(19) United States
(12) Patent Application Publication
(10) Pub. No.: US 2026/0285510 A1
(43) Pub. Date: Sep. 24, 2026

(54) ELECTRIC FLIGHT VEHICLE

(71) Applicant: MITSUBISHI HEAVY INDUSTRIES, LTD., Tokyo (JP)

(72) Inventors: Yuki MORISAKI, Tokyo (JP); Suguru HASE, Tokyo (JP); Satoshi YAMASHITA, Tokyo (JP); Yoshihiro KUWAMURA, Tokyo (JP); Yuichi NAKATANI, Tokyo (JP); Yuki ODA, Tokyo (JP)

(73) Assignee: MITSUBISHI HEAVY INDUSTRIES, LTD., Tokyo (JP)

(21) Appl. No.: 19/469,964

(22) PCT Filed: Sep. 21, 2023
(86) PCT No.: PCT/JP2023/034313

§ 371 Date: Sep. 26, 2025

(30) Foreign Application Priority Data
Mar. 30, 2023 (JP) 2023-054551

(51) Int. Cl. B64U 20/70; B64C 7/00; B64C 27/82; B64D 27/34; B64U 10/16; B64U 50/18; B64U 50/19; B64U 101/64

(52) U.S. Cl. CPC B64U 20/70; B64C 7/00; B64C 27/82; B64D 27/34; B64U 10/16; B64U 50/18; B64U 50/19; B64C 2027/8245; B64C 39/001; B64U 2101/64

(57) ABSTRACT

This electric flight vehicle is provided with: an airframe; a central propulsor that is disposed in a region including the position of the center of gravity of the airframe in a plan view and has an electric motor, a fan, and a duct; a manifold that is connected to the outlet of the central propulsor and extends in a plurality of different directions to divert the airflow in the plurality of directions; a thrust vectoring unit that is provided at each outlet of the manifold to thrust-vector the airflow; a thrust vectoring actuator unit that controls the attitude of the thrust vectoring unit; a cargo platform that is provided above the central propulsor and has a loading surface on which a cargo is loaded; and a support unit that connects the cargo platform to the airframe.

### DESCRIPTION

### Technical Field

The present disclosure relates to a method for controlling an electric flight vehicle.

This application claims the right of priority based on Japanese Patent Application No. 2023-054551 filed with the Japan Patent Office on Mar. 30, 2023, the content of which is incorporated herein by reference.

### Background Art

In recent years, the use of electric flight vehicles typified by drones and multicopters has been expanding (for example, PTL 1 below). An electric flight vehicle mainly includes an airframe and a plurality of propulsors provided in the airframe. In a case of being used for transport of cargo or supplies, it is common to hang the cargo or the like below the airframe or to accommodate the cargo or the like in an accommodation space provided in a lower portion of the airframe.

### CITATION LIST

### Patent Literature

[PTL 1] PCT Japanese Translation Patent Publication No. 2018-529571

### SUMMARY OF INVENTION

### Technical Problem

However, in a case where the cargo is hung below the airframe as described above, it may be difficult to balance the cargo in the air. In addition, in a case where cargo or the like is accommodated in the lower accommodation space, a worker has to work in a low posture when handling the cargo or the like on the ground, and thus there is a problem in that workability and efficiency are reduced.

The present disclosure provides an electric flight vehicle in which it is possible to more easily and efficiently perform cargo handling work.

### Solution to Problem

An electric flight vehicle according to the present disclosure includes: an airframe; a central propulsor that is disposed in a region including a gravity center position of the airframe in a plan view and that includes an electric motor, a fan which is rotationally driven by the electric motor, and a tubular duct which covers the fan from an outer periphery side; a manifold that is connected to an outlet of the central propulsor and that extends in a plurality of different directions to divert an airflow in the plurality of directions; a thrust vectoring unit that is provided at each outlet of the manifold and that thrust-vectors the airflow; a thrust vectoring actuator unit that controls an angle of the thrust vectoring unit; a cargo platform that is provided above the central propulsor and that has a loading surface on which cargo is loaded; and a supporting part that connects the cargo platform to the airframe.

### Advantageous Effects of Invention

According to the present disclosure, it is possible to provide an electric flight vehicle in which it is possible to more easily and efficiently perform cargo handling work.

### BRIEF DESCRIPTION OF DRAWINGS

FIG. 1 is a plan view showing a configuration of an electric flight vehicle according to an embodiment of the present disclosure.

FIG. 2 is a side view showing the configuration of the electric flight vehicle according to the embodiment of the present disclosure.

FIG. 3 is a functional block diagram showing a configuration of a control unit according to the embodiment of the present disclosure.

FIG. 4 is a flowchart showing a control flow when the control unit according to the embodiment of the present disclosure causes an airframe to move horizontally.

FIG. 5 is an explanatory diagram showing an operation of a thrust vectoring unit, a flow direction of a fluid, and momentum when the airframe is moved horizontally, and is a view when the airframe is viewed from above.

FIG. 6 is an explanatory diagram showing a relationship between the operation of the thrust vectoring unit, the flow direction of the fluid, and a magnitude of the momentum when the airframe is moved horizontally, and is a view when the airframe is viewed from a horizontal direction.

FIG. 7 is an explanatory diagram showing the operation of the thrust vectoring unit and the flow direction of the fluid when the airframe is rotated around a yaw axis.

FIG. 8 is a perspective view showing a configuration of a cargo platform according to the embodiment of the present disclosure.

FIG. 9 is a view of the cargo platform according to the embodiment of the present disclosure, as viewed from above.

FIG. 10 is a side view showing a modification example of the cargo platform according to the embodiment of the present disclosure.

FIG. 11 is a schematic diagram showing a modification example of the thrust vectoring unit according to the embodiment of the present disclosure.

FIG. 12 is a hardware configuration diagram of the control unit according to each embodiment of the present disclosure.

### DESCRIPTION OF EMBODIMENTS

### First Embodiment

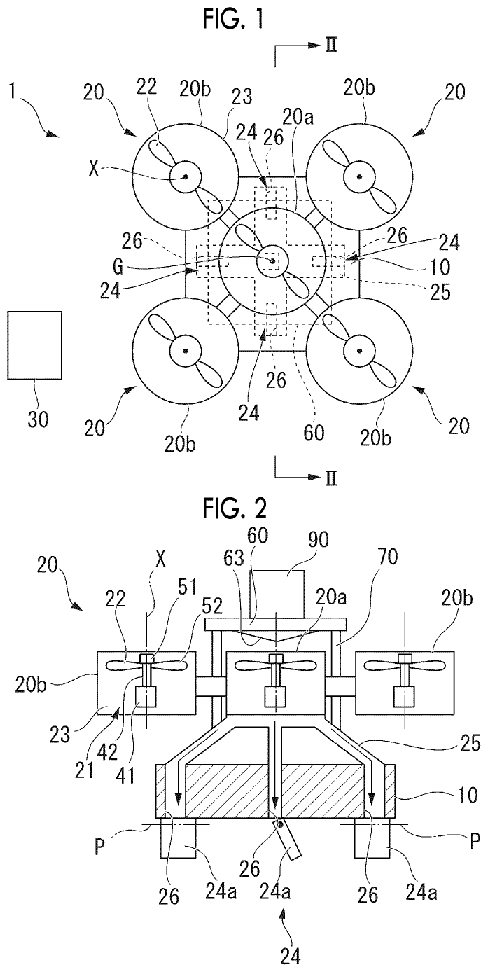

Hereinafter, an electric flight vehicle 1 and a method for controlling the electric flight vehicle 1 according to a first embodiment of the present disclosure will be described with reference to FIGS. 1 to 10. As the use of the electric flight vehicle 1 according to the present embodiment, in addition to the transport of articles between two points, it is assumed that the electric flight vehicle 1 is used for ascending or descending of materials between a low place and a high place.

### (Configuration of Electric Flight Vehicle 1)

As shown in FIG. 1 or FIG. 9, the electric flight vehicle 1 includes an airframe 10, a central propulsor 20a, a peripheral propulsor 20b, a manifold 25, a thrust vectoring unit 24, a thrust vectoring actuator unit, a control unit 30, a cargo platform 60, a supporting part 70 (refer to FIG. 9), and a fairing portion 64 (refer to FIG. 9). The airframe 10 accommodates various devices such as a battery, a GPS sensor, and a transmission/reception device. Although not shown in detail, the airframe 10 may be formed with a space for loading articles or cargo 90. In the example of FIG. 1, the airframe 10 has a rectangular shape in a plan view as an example. The central propulsor 20a is provided in a region including a gravity center position G of the airframe 10. One peripheral propulsor 20b is disposed at each of four corners so as to surround the central propulsor 20a from an outer periphery side. That is, a pair of peripheral propulsors 20b is provided on each diagonal line with a geometric gravity center position G of the rectangular airframe 10 interposed therebetween, and a total of four peripheral propulsors 20b are provided.

### (Configurations of Central Propulsor 20a and Peripheral Propulsor 20b)

The central propulsor 20a and the peripheral propulsor 20b have the same configuration except that they are provided at different positions. Therefore, hereinafter, these are collectively referred to as a propulsor 20, and a configuration thereof will be described. The propulsor 20 is a device for generating thrust when the airframe 10 ascends or descends, moves horizontally, and yaws. The propulsor 20 includes an electric motor 21, a fan 22, and a duct 23.

The electric motor 21 includes an electric motor main body 41 and an output shaft 42. The electric motor main body 41 accommodates a stator and a rotor core. The output shaft 42 is integrally connected to the rotor core. The output shaft 42 extends along the axis X and is rotatable around the axis X. The fan 22 is attached to a shaft end of the output shaft 42. The fan 22 includes a spinner 51 and a blade 52. The spinner 51 has a disk shape centered on the axis X. The spinner 51 may have a pointed shape protruding in the direction of the axis X. The spinner 51 rotates around the axis X in an integrated manner with the output shaft 42.

A plurality of blades 52 extending in a radial direction from an outer peripheral surface of the spinner 51 are provided at intervals in a circumferential direction. In the example of FIGS. 1 and 2, two blades 52 are provided. The number of blades 52 is not limited to two, and may be three or more. The blade 52 has an airfoil-shaped cross-sectional shape when viewed in the radial direction. The blades 52 rotate around the axis X together with the spinner 51, so that a flow of air from one side toward the other side in the direction of the axis X is generated. The pressure (dynamic pressure) of the flow of the air serves as thrust for ascending or the like of the airframe 10. In the following description, in a flow direction of an airflow, a side to which the airflow flows away may be referred to as a “downstream side”, and a side opposite to the downstream side may be referred to as an “upstream side”.

The duct 23 has a tubular shape that covers the electric motor 21 and the fan 22 from an outer periphery side. That is, the duct 23 has a tubular shape centered on the axis X. The space inside the duct 23 serves as a flow path through which the airflow generated by the blade 52 passes. The duct 23 is connected to the electric motor main body 41 by a stay. A plurality of the stays extend in the radial direction and are provided at intervals in the circumferential direction. In addition, the electric motor main body 41 may be accommodated in an inner cylinder, and the duct 23 may be supported by bridging a stay between the inner cylinder and the duct 23.

The manifold 25 is connected to an end portion on the downstream side of the central propulsor 20a. The manifold 25 is provided in order to divert the airflow that has passed through the duct 23 of the central propulsor 20a into a plurality of flows. As shown in FIG. 1, four outlet-side openings 26 of the manifold 25 are open on the lower surface of the airframe 10 in a distributed manner. In these four outlet-side openings 26, one outlet-side opening 26 is provided on each side of the airframe 10 having a rectangular shape. Each outlet-side opening 26 has a rectangle in which a direction intersecting each side of the airframe 10 is a long side. The airflow that has passed through the duct 23 branches toward the outlet-side openings 26, and the airflow is dispersed and jetted from each outlet-side opening 26.

The thrust vectoring unit 24 is a device for thrust-vectoring the airflow flowing out from the outlet-side opening 26 of the manifold 25 to change a thrust direction. The thrust vectoring unit 24 is rotatable around a rotation axis P extending in the radial direction with respect to the axis X of the central propulsor 20a. The thrust vectoring unit 24 is formed of a plate-shaped flap 24a that extends toward the downstream side from the rotation axis P. As shown in FIG. 1, four thrust vectoring units 24 are provided at intervals of 90° in the circumferential direction. A thrust vectoring actuator unit (not shown) is connected to each of the thrust vectoring units 24. As shown in FIG. 2, the thrust vectoring actuator unit is an actuator that rotates the thrust vectoring unit 24 around the rotation axis P. The thrust vectoring actuator unit is electrically connected to a control unit 30 (described later), and a drive state thereof is controlled based on an electric signal sent from the control unit 30. Each of the thrust vectoring units 24 is configured to be controlled independently of each other.

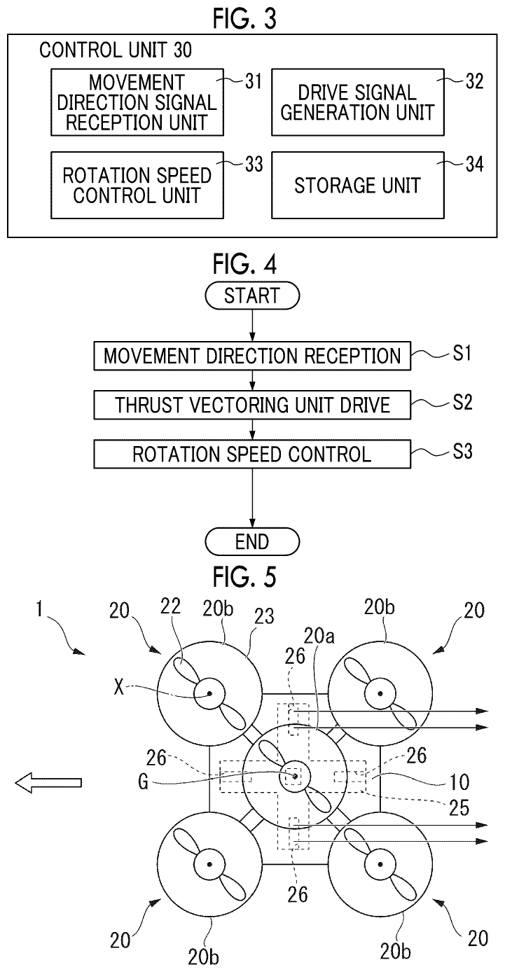

As shown in FIG. 3, the control unit 30 includes a movement direction signal reception unit 31, a drive signal generation unit 32, a rotation speed control unit 33, and a storage unit 34. The movement direction signal reception unit 31 acquires a direction in which the airframe 10 is to be moved, for example, based on a signal input by an operator via remote control. In the following description, the direction in which the airframe 10 moves is simply referred to as a “movement direction D”. The movement direction D is any direction in the horizontal plane.

The drive signal generation unit 32 transmits a signal for driving the thrust vectoring unit 24 to the thrust vectoring actuator unit, based on the movement direction D received by the movement direction signal reception unit 31. That is, which thrust vectoring unit 24 is rotated in which direction and by how much is determined depending on the movement direction D.

The rotation speed control unit 33 controls the rotation speed of each propulsor 20, based on the movement direction D. Details of the operation of the rotation speed control unit 33 will be described later. The storage unit 34 stores various types of information as electric signals. For example, the relationship between the movement direction D, the moving speed, the rotation angle of the thrust vectoring unit 24, and the rotation speed of the propulsor 20, and the like are stored in the storage unit 34 in advance.

Next, the behavior of each device when the electric flight vehicle 1 moves horizontally in the movement direction D will be described with reference to FIGS. 4 to 6. As shown in FIG. 4, when the movement direction D is input by the operator, in step S1, the movement direction signal reception unit 31 receives information about the movement direction D. Subsequently, in step S2, the thrust vectoring unit 24 is driven in accordance with the movement direction D. Specifically, the drive signal generation unit 32 that has received the signal related to the movement direction D from the movement direction signal reception unit 31 transmits a predetermined electric signal to the thrust vectoring actuator unit. In this way, the thrust vectoring unit 24 rotates by a predetermined angle in a predetermined direction. Then, the direction (thrust direction) of the airflow flowing out from the central propulsor 20a is changed. In this way, thrust as a reaction force of the airflow toward a side opposite to the movement direction D is applied to the airframe 10 (refer to FIG. 5).

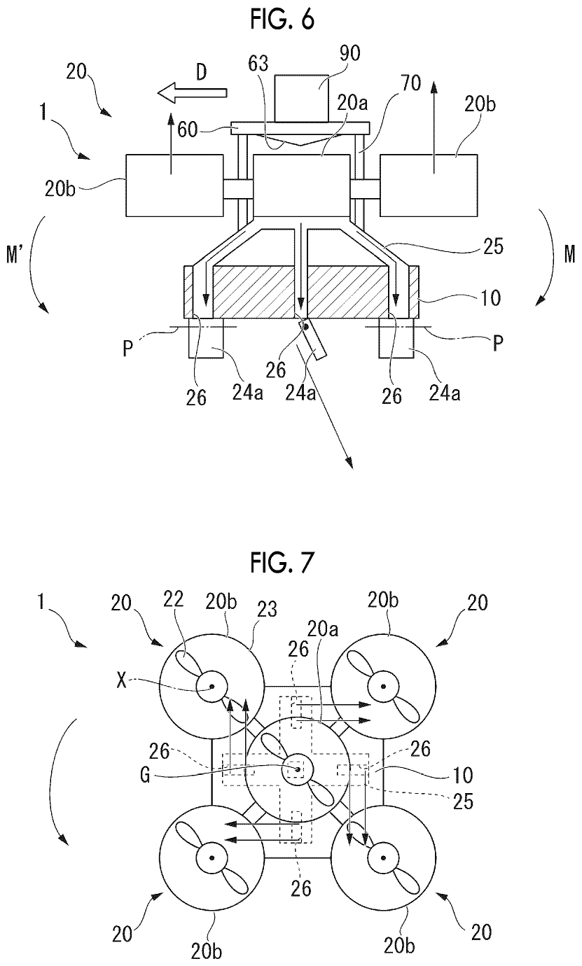

At this time, as shown in FIG. 6, when viewed from the horizontal direction orthogonal to the movement direction D, a pitching moment M with the direction as an axis is generated in the airframe 10. Specifically, for example, when the airframe 10 is moved to the left side of the paper surface as shown in FIG. 6, the pitching moment M in a clockwise direction is generated in the airframe 10. When the pitching moment M increases, the airframe 10 is inclined in the clockwise direction. Therefore, the rotation speed control unit 33 generates a counter-moment M′ for canceling the pitching moment M by controlling the rotation speed of the peripheral propulsor 20b (step S3). In a case where the plurality of peripheral propulsors 20b are considered to be divided into the peripheral propulsor 20b located on one side (a moving side: a front side) in the movement direction D and the peripheral propulsor 20b located on the other side (a rear side) with the center of gravity of the airframe 10 interposed therebetween, the rotation speed control unit 33 controls the rotation speed of the peripheral propulsor 20b located on the one side in the movement direction D to be higher than the rotation speed of the peripheral propulsor 20b on the other side. That is, as indicated by the difference in the momentum of the fluid flowing out from the propulsor 20 as the length of the arrow in FIG. 6, the thrust by the peripheral propulsor 20b on the one side is made larger than the thrust by the peripheral propulsor 20b on the other side. Then, the counter-moment M′ in a counterclockwise direction is generated. In this way, the pitching moment M described above is canceled out. Therefore, the airframe 10 moves toward one side in the movement direction D without tilting, that is, without pitching.

Further, it is also possible to yaw the airframe 10 by operating the thrust vectoring unit 24 in addition to the horizontal movement in the movement direction D. Yawing refers to an operation of rotating the airframe 10 around a yaw axis passing through the center of gravity of the airframe 10. As shown in FIG. 7, when yawing is performed, thrust is generated in the circumferential direction around the axis X passing through the gravity center position G by rotating each of the thrust vectoring units 24 by the same angle in the same direction. That is, thrust is generated from one side toward the other side in the circumferential direction at each outlet-side opening 26 of the manifold 25. In this way, a moment from one side in the circumferential direction to the other side around the yaw axis is generated in the entire electric flight vehicle 1, and a yawing motion is performed. The movement and the posture of the electric flight vehicle 1 are controlled by appropriately combining the horizontal movement and the yawing motion as described above.

### (Configuration of Cargo Platform 60)

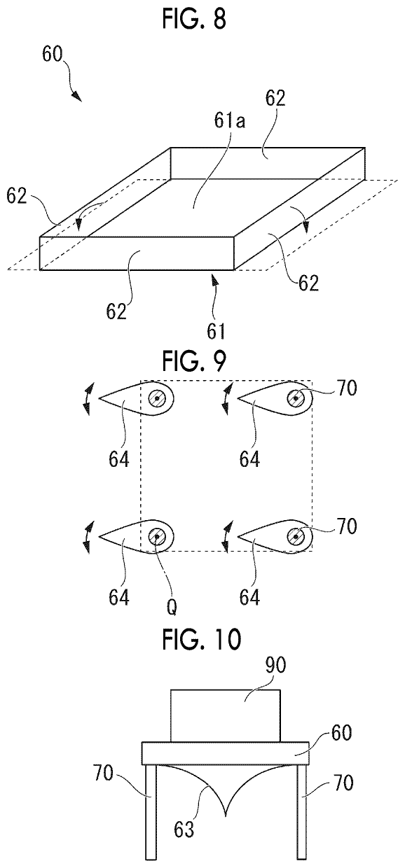

The cargo platform 60 is supported in a space above the airframe 10 via the supporting part 70. The cargo platform 60 is a member for loading the cargo 90 thereon. As shown in FIG. 8, the cargo platform 60 has a platform main body 61 and a plate portion 62. The platform main body 61 has a rectangular plate shape disposed to cover the central propulsor 20a from above. An upper surface of the platform main body 61 (that is, a surface facing a side opposite to the central propulsor 20a) serves as a loading surface on which the cargo 90 is loaded. As shown in FIG. 1 or FIG. 6, a lower surface of the platform main body 61 serves as an airflow guide surface 63 that extends toward the central propulsor 20a side toward an inner side from a radial outer side with respect to a central axis O of the airframe 10. That is, the airflow guide surface 63 has a conical surface shape.

The supporting parts 70 are attached to four corners of the airflow guide surface 63. The supporting part 70 has a columnar shape extending toward the airframe 10 side. A space for taking in air is formed between the platform main body 61 and the central propulsor 20a by being supported by the supporting parts 70. The plate portions 62 are rotatably attached to four end edges of the platform main body 61. As shown in FIG. 8, the plate portion 62 is rotatable between a state where the loading surface is surrounded from the outer side and a state where the loading surface is flush with the plate portion 62.

Further, as shown in FIG. 9, the fairing portion 64 is provided around the supporting part 70. The fairing portion 64 is rotatable around a rotation axis Q extending in the extending direction of the supporting part 70. The fairing portion 64 has an airfoil-shaped cross-sectional shape when viewed in the direction of the rotation axis Q. When the electric flight vehicle 1 moves, the fairing portion 64 rotates such that the leading edge side thereof faces the front side in the movement direction D and the trailing edge side faces the rear side. The fairing portion 64 extends over the entire region of the extending dimension of the supporting part 70. The fairing portion 64 is mounted on an outer peripheral surface of the supporting part 70 via a bearing device.

### (Operation and Effect)

Here, in a case where the electric flight vehicle 1 of the related art is used for transporting the cargo 90 or the supplies, it is common to hang the cargo 90 or the like below the airframe 10 or to accommodate the cargo 90 or the like in an accommodation space provided in a lower portion of the airframe 10. However, in a case where the cargo 90 is hung below the airframe 10 as described above, it may be difficult to balance the cargo 90 in the air. In addition, when the cargo 90 or the like is accommodated in a lower accommodation space, the worker has to work in a low posture when handling the cargo 90 or the like on the ground, and thus there is a problem in that workability and efficiency are reduced. Therefore, the electric flight vehicle 1 according to the present embodiment adopts each of the configurations described above.

According to the above-described configuration, since the cargo platform 60 is provided above the central propulsor 20a, the worker does not need to take a low posture when handling the cargo 90 on the ground. Therefore, it is possible to easily and efficiently proceed with the cargo handling work. In addition, since the cargo 90 is fixed to the cargo platform 60, it is not necessary to excessively manage the weight balance of the cargo 90 as compared with a case where the cargo 90 is hung below the airframe 10. In this way, it is possible to further improve the efficiency of the cargo handling work while maintaining the stability of the cargo 90.

Further, according to the above-described configuration, in a state where the plate portion 62 is open and the loading surface of the platform main body 61 and the plate portion 62 are flush with each other, the plate portion 62 does not interfere with the cargo 90. Therefore, large and long cargo 90 can be loaded on the cargo platform 60. In addition, in a state where the plate portion 62 is rotated to surround the loading surface, the possibility that the cargo 90 may be scattered from the loading surface can be reduced. In this manner, the cargo 90 can be stably loaded on the cargo platform 60 regardless of the dimensions or the shape of the cargo 90.

In addition, according to the above-described configuration, the fairing portion 64 having an airfoil-shaped cross-sectional shape rotates based on the movement direction D of the airframe 10. In this way, the leading edge side of the airfoil faces the front side in the movement direction D, and the trailing edge side faces the rear side in the movement direction D. Therefore, since air resistance that is generated in the supporting part 70 is reduced, it is possible to minimize a decrease in flight performance of the electric flight vehicle 1 due to the provision of the cargo platform 60. As a result, it is possible to maintain a range or an ascent altitude of the electric flight vehicle 1 as before.

Further, according to the above-described configuration, the flow of air sucked by the central propulsor 20a is guided by the airflow guide surface 63. In this way, a pressure loss that occurs in the sucked air is reduced, and the central propulsor 20a can be driven more efficiently. Therefore, it is possible to maintain the range or the ascent altitude of the electric flight vehicle 1 at a higher level.

In addition, according to the above-described configuration, the thrust direction of the central propulsor 20a can be freely adjusted by changing the direction of the airflow flowing out from the manifold 25 by the thrust vectoring unit 24. In this way, the horizontal movement or the position adjustment can be performed without greatly changing the posture of the electric flight vehicle 1. Therefore, it is possible to stably and smoothly transport the object to the destination without breaking the weight balance of the object or the like loaded on the airframe 10. Furthermore, since time is not required for tilting the airframe 10 immediately before the movement, the possibility of being affected by a gust of wind or the like during the time can be reduced. Therefore, it is possible to realize a more stable operation of the electric flight vehicle 1. In addition, the rotation operation of the electric flight vehicle 1 around the yaw axis can also be realized by making the direction of the airflow coincide with the direction from one side to the other side in the circumferential direction around the center of gravity by the thrust vectoring unit 24. In this manner, it is possible to easily perform minute movement, position adjustment, and yawing.

Further, according to the above-described configuration, the direction of the airflow flowing from the duct 23 can be changed only by changing the rotation angle of the flap 24a serving as the thrust vectoring unit 24. In this way, it is possible to easily perform minute movement, position adjustment, and yawing with a simple configuration. In addition, since the thrust direction is immediately changed when the rotation angle of the thrust vectoring unit 24 is changed, the responsiveness of the electric flight vehicle 1 to the piloting operation can also be improved.

In addition, according to the above-described configuration, first, the control unit 30 operates the thrust vectoring unit 24 to generate the thrust directed to the rear side in the movement direction D. At that time, the pitching moment M with the horizontal direction as an axis occurs in the airframe 10. Therefore, the rotation speed control unit 33 makes the rotation speed of the electric motor 21 of the peripheral propulsor 20b located on the front side in the movement direction D higher than the rotation speed of the electric motor 21 of the peripheral propulsor 20b located on the rear side. In this way, the counter-moment M′ in the opposite direction is generated, and the pitching moment M is canceled out. Therefore, the airframe 10 can be moved in the movement direction D without being tilted. In this way, the airframe 10 can be smoothly moved without being affected by the weight balance of the cargo 90 or an external force due to a gust. In particular, it is advantageous when transporting delicate articles that are damaged when tilted or long articles that are difficult to balance in weight.

In addition, according to the above-described configuration, the thrust vectoring unit 24 generates the thrust around the yaw axis, so that the airframe 10 can be rotated on the spot. In addition, conversely, when the airframe 10 is unintentionally rotated by an external force such as wind, the airframe 10 can be immediately restored to the initial posture by performing the above operation. In this way, the precision and accuracy of the posture control of the electric flight vehicle 1 are improved, and the electric flight vehicle 1 can be used for various purposes, in addition to movement and transport. That is, the versatility of the electric flight vehicle 1 can be greatly improved.

In addition, since the thrust vectoring units 24 are disposed to be centralized at the outlet-side opening 26 of the manifold 25, the number of movable portions can be reduced as compared to a configuration in which the thrust vectoring units 24 are provided in the ducts 23 of the respective propulsors 20, for example. In this way, the number of components can be reduced, and maintenance costs and manufacturing costs can be significantly reduced.

### Other Embodiments

Although the embodiment of the present disclosure has been described in detail above with reference to the drawings, the specific configuration of the present disclosure is not limited to the embodiment, and the present disclosure includes design changes or the like without departing from the scope of the present disclosure.

For example, as a modification example of the cargo platform 60, a configuration shown in FIG. 10 can also be adopted. In the example of FIG. 10, the airflow guide surface 63 which is the lower surface of the cargo platform 60 has a curved surface shape to gradually get away from the central propulsor 20a toward an inner side from a radial outer side. According to this configuration, since the airflow guide surface 63 has a curved surface shape, the flow of the airflow is further smoothed. In this way, since a pressure loss, a vortex, flow separation, or the like occurring in the airflow is further reduced, the central propulsor 20a can be driven more efficiently.

In addition, it is also possible to provide a cover or a hood that covers the cargo 90 on the cargo platform 60 as long as the dimension and physical size of the cargo 90 are allowed. According to this configuration, it is possible to minimize a decrease in aerodynamic performance regardless of the shape of the cargo 90. In addition, it is also possible to protect the cargo 90 from wind and rain.

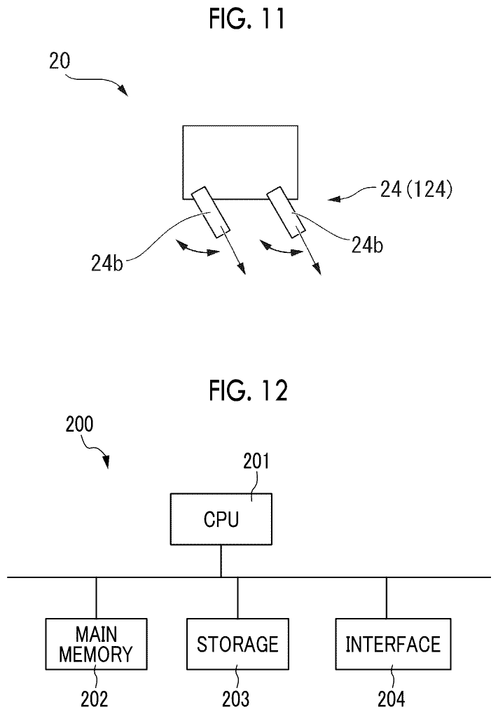

In addition, it is also possible to adopt a configuration shown in FIG. 11 as a modification example of the thrust vectoring unit 24. In the example of FIG. 11, the thrust vectoring unit 24 has a nozzle 24b which extends from the duct 23 toward the downstream side of the airflow and in which a direction of the outlet can be freely changed. The nozzle 24b has a tubular shape, and a flow path through which an airflow flows is formed inside the nozzle 24b. With this configuration as well, the same operation and effects as those described above can be obtained. In addition, the nozzle 24b may be formed of a material that is elastically deformable.

Further, the shape of the airframe 10 described in the above embodiment is an example, and any shape or dimension and physical size appropriately selected according to design and specifications can be adopted. Even though the shape or the dimension and physical size of the airframe 10 changes, the configuration and the control flow described in the above embodiment can be applied. In addition, the number of the propulsors 20 may be appropriately determined according to the shape, the dimension and physical size, the weight, or the like of the airframe 10.

In addition, the configuration of the propulsor 20 itself described in the above embodiment is also an example, and a configuration in which a stator vane is further provided on the downstream side of the fan 22 can be adopted. The stator vane is provided to straighten the flow of air pumped by the fan 22. With this configuration as well, the same operation and effects as those described above can be obtained.

Further, in the control unit 30, it is desirable that the generation of the drive signal by the drive signal generation unit 32 and the control of the rotation speed by the rotation speed control unit 33 are autonomously performed after the movement direction signal reception unit 31 receives the input of the movement direction D. In other words, it is desirable that the user inputs only the movement direction D and the subsequent processing is autonomously performed by the control unit 30. Similarly, a configuration may be made such that after receiving the input of the movement direction D, the yawing is automatically performed by the drive signal generation unit 32 and the rotation speed control unit 33.

The airframe 10 described above may be capable of accommodating personnel. In that case, it is desirable that the airframe 10 is equipped with a flight control device and a navigation device.

In addition, the rotation speed of the thrust vectoring unit 24 may be changed based on the input of an acceleration in the movement direction D. In this way, the airframe 10 can be precisely controlled in accordance with the input acceleration in the movement direction D.

In a processing flow of the control unit 30 of the embodiment of the present disclosure, the order of processing may be changed in a range in which appropriate processing is performed.

Each of the storage unit 34 and other storage devices in the embodiment of the present disclosure may be provided anywhere in a range in which appropriate information is transmitted and received. Further, each of the storage unit 34 and the other storage devices may be present in a plurality in a range in which appropriate information is transmitted and received, and data may be stored in a distributed manner.

The process of the processing by the control unit 30 described above is stored in the form of a program in a recording medium that can be read by a computer 200, and the computer 200 reads out and executes this program, so that the processing is performed. A specific example of the computer 200 will be described below.

As shown in FIG. 12, the computer 200 includes a CPU 201, a main memory 202, a storage 203, and an interface 204.

For example, the control unit 30 described above is mounted on the computer 200. Then, the operation of each processing unit described above is stored in the storage 203 in the form of a program. The CPU 201 reads the program from the storage 203, develops the program in the main memory 202, and executes the above processing according to the program. Further, the CPU 201 secures a storage area corresponding to the storage unit 34 described above in the main memory 202 according to the program.

As examples of the storage 203, a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like can be given. The storage 203 may be an internal medium directly connected to a bus of the computer 200 or may be an external medium that is connected to the computer 200 via the interface 204 or a communication line. Further, in a case where this program is distributed to the computer 200 via a communication line, the computer 200 receiving the distribution may develop the program in the main memory 202 and execute the above processing. The storage 203 is a non-temporary tangible storage medium.

In addition, the program may realize some of the functions described above. Furthermore, the program may be a so-called differential file (differential program) that can realize the above-described functions in combination with a program already recorded in the computer 200.

A custom large scale integrated circuit (LSI) such as a programmable logic device (PLD), an application specific integrated circuit (ASIC), a graphics processing unit (GPU), and a processing device similar thereto may be provided in addition to the above-described configuration or instead of the above-described configuration. As examples of the PLD, a programmable array logic (PAL), a generic array logic (GAL), a complex programmable logic device (CPLD), and a field programmable gate array (FPGA) can be given. In this case, a part or all of the functions that are realized by the processor may be realized by the integrated circuit.

### Additional Remark

The electric flight vehicle 1 described in each embodiment is understood as follows, for example.

(1) An electric flight vehicle 1 according to a first aspect includes: an airframe 10; a central propulsor 20a that is disposed in a region including a gravity center position G of the airframe 10 in a plan view and that includes an electric motor 21, a fan 22 which is rotationally driven by the electric motor 21, and a tubular duct 23 which covers the fan 22 from an outer periphery side; a manifold 25 that is connected to an outlet of the central propulsor 20a and that extends in a plurality of different directions to divert an airflow in the plurality of directions; a thrust vectoring unit 24 that is provided at each outlet of the manifold 25 and that thrust-vectors the airflow; a thrust vectoring actuator unit that controls an angle of the thrust vectoring unit 24; a cargo platform 60 that is provided above the central propulsor 20a and that has a loading surface on which cargo 90 is loaded; and a supporting part 70 that connects the cargo platform 60 to the airframe 10.

According to the above-described configuration, since the cargo platform 60 is provided above the central propulsor 20a, the worker does not need to take a low posture when handling the cargo 90 on the ground. Therefore, it is possible to easily and efficiently proceed with the cargo handling work. In addition, since the cargo 90 is fixed to the cargo platform 60, it is not necessary to excessively manage the weight balance of the cargo 90 as compared with a case where the cargo 90 is hung below the airframe 10. In this way, it is possible to further improve the efficiency of the cargo handling work while maintaining the stability of the cargo 90.

(2) In an electric flight vehicle 1 according to a second aspect, in the electric flight vehicle 1 according to the above (1), the cargo platform 60 includes a rectangular platform main body 61 having the loading surface, and a plate portion 62 rotatably connected to an end edge of the platform main body 61.

According to the above-described configuration, in a state where the plate portion 62 is open and the loading surface of the platform main body 61 and the plate portion 62 are flush with each other, large and long cargo 90 can be loaded. In addition, in a state where the plate portion 62 is rotated to surround the loading surface, the possibility that the cargo 90 may be scattered from the loading surface can be reduced.

(3) In an electric flight vehicle 1 according to a third aspect, the electric flight vehicle 1 according to the above (1) or (2) further includes: a fairing portion 64 that is provided to be rotatable with respect to the supporting part 70 around a rotation axis Q with an extending direction of the supporting part 70 as an axis, and that has an airfoil-shaped cross-sectional shape when viewed from a direction of the rotation axis Q.

According to the above-described configuration, the fairing portion 64 having an airfoil-shaped cross-sectional shape rotates based on the movement direction D of the airframe 10. In this way, the leading edge side of the airfoil faces the front side in the movement direction D, and the trailing edge side faces the rear side in the movement direction D. Therefore, air resistance that is generated in the supporting part 70 can be reduced.

(4) In an electric flight vehicle 1 according to a fifth aspect, in the electric flight vehicle 1 according to any one of the above (1) to (3), a surface of the cargo platform 60 facing a central propulsor 20a side forms an airflow guide surface 63 by extending toward the central propulsor 20a side toward an inner side from a radial outer side with respect to a central axis O of the airframe 10 passing through the gravity center position G.

According to the above-described configuration, the flow of air sucked by the central propulsor 20a is guided by the airflow guide surface 63. In this way, a pressure loss that occurs in the sucked air is reduced, and the central propulsor 20a can be driven more efficiently.

(5) In an electric flight vehicle 1 according to a fifth aspect in the electric flight vehicle 1 according to the above (4), the airflow guide surface 63 has a curved surface shape to gradually get away from the central propulsor 20a toward the inner side from the radial outer side.

According to the above-described configuration, since the airflow guide surface 63 has a curved surface shape, the flow of the airflow is further smoothed. In this way, since a pressure loss, a vortex, flow separation, or the like occurring in the airflow is further reduced, the central propulsor 20a can be driven more efficiently.

### INDUSTRIAL APPLICABILITY

According to the present disclosure, it is possible to provide an electric flight vehicle in which it is possible to more easily and efficiently perform cargo handling work.

### REFERENCE SIGNS LIST

1: electric flight vehicle
10: airframe
20: propulsor
20a: central propulsor
20b: peripheral propulsor
21: electric motor
22: fan
23: duct
24: thrust vectoring unit
24a: flap
24b: nozzle
25: manifold
26: outlet-side opening
30: control unit
31: movement direction signal reception unit
32: drive signal generation unit
33: rotation speed control unit
34: storage unit
41: electric motor main body
42: output shaft
51: spinner
52: blade
60: cargo platform
61: platform main body
61a: loading surface
62: plate portion
63: airflow guide surface
64: fairing portion
70: supporting part
90: cargo
120: horizontal propulsor
124: duct thrust vectoring unit
200: computer
201: CPU
202: main memory
203: storage
204: interface
D: movement direction
G: gravity center position
M: pitching moment
M′: counter-moment
O: central axis
P: rotation axis
Q: rotation axis
X: axis

1. An electric flight vehicle comprising:
an airframe;
a central propulsor that is disposed in a region including a gravity center position of the airframe in a plan view and that includes an electric motor, a fan which is rotationally driven by the electric motor, and a tubular duct which covers the fan from an outer periphery side;
a manifold that is connected to an outlet of the central propulsor and that extends in a plurality of different directions to divert an airflow in the plurality of directions;
a thrust vectoring unit that is provided at each outlet of the manifold and that thrust-vectors the airflow;
a thrust vectoring actuator unit that controls an angle of the thrust vectoring unit;
a cargo platform that is provided above the central propulsor and that has a loading surface on which cargo is loaded;
a supporting part that connects the cargo platform to the airframe, and
a fairing portion that is provided to be rotatable with respect to the supporting part around a rotation axis with an extending direction of the supporting part as an axis, and that has an airfoil-shaped cross-sectional shape when viewed from a direction of the rotation axis.

2. The electric flight vehicle according to claim 1,
wherein the cargo platform includes a rectangular platform main body having the loading surface, and a plate portion rotatably connected to an end edge of the platform main body.

3. (canceled)

4. The electric flight vehicle according to claim 1,
wherein a surface of the cargo platform facing a central propulsor side forms an airflow guide surface by extending toward the central propulsor side toward an inner side from a radial outer side with respect to a central axis of the airframe passing through the gravity center position.

5. The electric flight vehicle according to claim 4,
wherein the airflow guide surface has a curved surface shape to gradually get away from the central propulsor toward the radial outer from the inner side.
